(19) United States
(12) Patent Application Publication
(10) Pub. No.: US 2013/0229440 A1
(43) Pub. Date: Sep. 5, 2013

(54) STATE AWARE TILE VISUALIZATION

(71) Applicants: Brian Whalen MacDonald, Bellevue, WA (US); Mira Lane, Redmond, WA (US); Phoi Heng Lew, Mill Creek, WA (US); Anthony Kitowicz, Kirkland, WA (US); Sudin Bhat, Redmond, WA (US)

(72) Inventors: Brian Whalen MacDonald, Bellevue, WA (US); Mira Lane, Redmond, WA (US); Phoi Heng Lew, Mill Creek, WA (US); Anthony Kitowicz, Kirkland, WA (US); Sudin Bhat, Redmond, WA (US)

(73) Assignee: Microsoft Corporation, Redmond, WA (US)

(21) Appl. No.: 13/409,792

(22) Filed: Mar. 1, 2012

(51) Int. Cl. G09G 5/00

(52) U.S. Cl. 345/681; 345/619

(57) ABSTRACT

One or more techniques and/or systems are provided for selecting images to represent tiles within a visualization and/or for creating a visually diverse visualization. That is, images for tiles within a visualization may be selected and/or modified based upon state information associate with such tiles (e.g., current time, current location, device resolution, current weather conditions, current image comprised within a tile, etc.). In this way, a set of visually diverse tiles may be created, such that adjacent tiles may be represented by visually diverse images. For example, tiles within a weather application may represent weather conditions for days of a week. If two adjacent tiles comprise visually similar images (e.g., images depicting a single cloud), then at least one of the images may be modified (e.g., to an image of four clouds) so that the two adjacent tiles may appear visually dissimilar within the weather application.

### BACKGROUND

Today, computing devices display information to users in a variety of formats, such as a tile format. In one example, a mobile operating system may display applications using such a tile format (e.g., an application may be represented by an image within a tile). In another example, a weather application may display daily weather information in a tile format (e.g., weather information for a particular day may be represented by an image and/or text within a tile). In this way, a plethora of information may be represented by tiles, such as applications, weather, maps, directions, videos, and/or other information. Tiles may be arranged within a visualization accordingly to various logical parameters (e.g., a tile representing weather for Tuesday may be placed adjacent to a tile representing whether for Monday and a tile representing weather for Wednesday). Tiles may be visually enhanced with images (e.g., a tile representing a rainy Tuesday may comprise a background image of clouds).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for selecting images to represent tiles within a visualization and/or creating a visually diverse visualization are provided herein. A visualization may correspond to a variety of visual interfaces configured to display information in a tiled format (e.g., a weather application, a mobile device interface, a tablet device interface, a smart phone interface, a desktop interface, an operating system desktop, an image browser interface, a map application, and/or any other form factor and/or application). A tile may correspond to a representation of information using the tile format (e.g., a weather application may display weather information for days of the week within tiles). For example, a tile may comprise an information tile, an application tile, a video tile, an image tile, etc. A tile may be visually displayed within a visualization using an image and/or text (e.g., a tile corresponding to a rainy Monday may comprise a background image of clouds; a tile corresponding to an email application may comprise an image of an envelope; etc.). Unfortunately, two adjacent tiles may be automatically assigned similar images (e.g., a tile representing a rainy Wednesday may comprise a similar background image of clouds as the tile representing a rainy Tuesday). In this way, a visualization may not comprise a visually diverse set of tiles, which may be unappealing and/or confusing to users. It may thus be advantageous to, as provided herein, assign and/or modify images for tiles within a visualization so that the visualization may comprise visually diverse tiles (e.g., so that adjacent tiles do not comprise similar images).

In one example of selecting images to represent tiles within a visualization, a first state of a first tile within a visualization may be determined. A state, such as the first state, may be based upon a current time, a current location of a device hosting the visualization, a device form factor (e.g., device resolution, device size, device orientation, etc.), a time at which a tile was last displayed within the visualization, user preference, and/or a variety of other state information (e.g., current weather conditions for weather tiles, current driving conditions for map/direction tiles, etc.). For example, a first state of a first weather tile (e.g., a Monday weather tile) may specify a sunny weather condition for a current location, a morning time of the day, a 100 pixel by 200 pixel tile size, and/or a variety of other state information. A second state of a second tile adjacent to the first tile within the visualization may be determined. For example, a second state of a second weather tile (e.g., a Tuesday weather tile) may specify a mostly sunny weather condition for a current location, a morning time of the day, a 100 pixel by 200 pixel tile size, and/or a variety of other state information.

A first image may be selected for the first tile based upon the first state. For example, a first image of a colorful sunrise may be selected for the first tile. A second image may be selected for the second tile based upon the second state. The second image may be different than the first image above a difference threshold (e.g., the difference threshold may specify a percentage of pixels that are to be different between the first and second image, such as 20%, for example). For example, a second image of a half-raised sun may be selected for the second tile. In this way, images may be selected for tiles within the visualization to create visual diversity (e.g., where adjacent tiles are represented by (sufficiently) visually diverse images). It may be appreciated that the difference threshold is not limited to an evaluation of pixel dissimilarity, but may be based upon other factors/evaluations, such as determining whether a file size of the first and second image are dissimilar and/or whether an identifier (e.g., a file name) of the first and second image are dissimilar, for example.

In one example of creating a visually diverse visualization, a first state of a first tile within a visualization may be determined (e.g., the first state may specify an image currently representing the first tile, a current time, a current location, a device form factor, etc.). The first state may be compared with a second state of a second tile adjacent to the first tile within the visualization to determine visual similarity (e.g., visual similarity may correspond to a percentage of pixels that are similar between a first image representing the first tile and a second image representing the second tile, for example). Responsive to the visual similarity being above a similarity threshold (e.g., the similarity threshold may specify an acceptable percentage of pixels that may be similar between the first and second image, such as 80%, for example), the first tile may be modified to be visually diverse from the second tile below the similarity threshold (e.g., the first image currently representing the first tile may be changed to a different image that may be (sufficiently) visually dissimilar from the second image representing the second tile). In this way, a visually diverse visualization may be created (e.g., where adjacent tiles are represented by visually diverse images). It may be appreciated that the similarity threshold is not limited to an evaluation of pixel similarity, but may be based upon other factors/evaluations, such as determining whether a file size of the first and second image are similar and/or whether an identifier (e.g., a file name) of the first and second image are similar.

It may be appreciated that the selection and/or modified of images for tiles is not limited to merely adjacent tiles, but may be extended to other images. In one example, images may be selected and/or modified for tiles within a visualization so that no tile comprises an image visually similar to tiles within at least a threshold number of tiles away. In another example, images may be selected and/or modified for tiles within a visualization so that no visible tiles on a device display comprise visually similar images. It may also be appreciated that the instant application, including the scope of the appended claims, is not limited any particular form factor (e.g., a mobile device, a tablet device, a desktop device, a smart phone device, etc.), but is instead applicable to any type of form factor and/or image, application, tile, etc. displayed thereon. Likewise, although much of the description herein is provided in the context of images, the application is not so limited. For example, videos, sound/audio, etc. may also be addressed to mitigate confusion among tiles. For example, alterations may be made to tiles comprising videos (e.g., in real-time/on the fly to dynamically changing/evolving imagery on the tiles) so that the (e.g., adjacent) tiles are, or substantially remain, sufficiently differentiable from one another.

It may be appreciated that in one example, a tile may correspond to an interactive object. That is, a tile may be associated with functionality and/or interactivity, and is not limited to merely a visual object (e.g., can navigate to an article, open a file, play a video, launch an application, etc. (e.g., akin to a shortcut, gadget, and/or hybrid between a shortcut and a gadget, etc.)). A tile can, for example, surface content or functionality associated with an underlying application. On a smartphone, for example, a tile for a contact might surface an image associated with the contact (e.g., Mom, Dad, friend, etc.). A tile for an email application might, for example, show a number of unread messages, periodically update with new email alerts and/or may allow a user to directly open an email from the email tile. A tile for a weather application that displays weather information about a particular location may, for example, comprise a link to more detailed information about that particular location. With regard to a news application, a tile may, for example, comprise a hyperlink to underlying content. In another example, a CPU temperature tile may display active temperature data and/or may allow a user to open a CPU configuration application from the CPU temperature tile.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of selecting images to represent tiles within a visualization.

FIG. 2 is a flow diagram illustrating an exemplary method of creating a visually diverse visualization.

FIG. 3 is a component block diagram illustrating an exemplary system for selecting images to represent tiles within a visualization.

FIG. 4 is a component block diagram illustrating an exemplary system for creating a visually diverse visualization.

FIG. 5 is a component block diagram illustrating an exemplary system for creating a visually diverse visualization.

FIG. 6 is an illustration of an exemplary computer-readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many visualizations may represent information as tiles. For example, a weather visualization may represent weather information for days of the week as a set of weather tiles arranged according to a tile format. A tile may comprise an image and/or other information (e.g., a weather tile may comprise textual weather information and/or a background image of a sunrise). It may be advantageous to populate a visualization with visually diverse tiles, which may enhance visual appeal to a user and/or mitigate confusion between tiles.

Accordingly, among other things, one or more systems and/or techniques for selecting images to represent tiles within a visualization and/or for creating a visually diverse visualization are provided herein. In particular, images may be selected for tiles within a visualization, such that adjacent tiles may comprise (sufficiently) visually dissimilar images. Similarly, an image for a tile may be modified based upon a determination that the image is visually similar to an image of an adjacent tile. In this way, a (sufficiently) visually diverse visualization may be created.

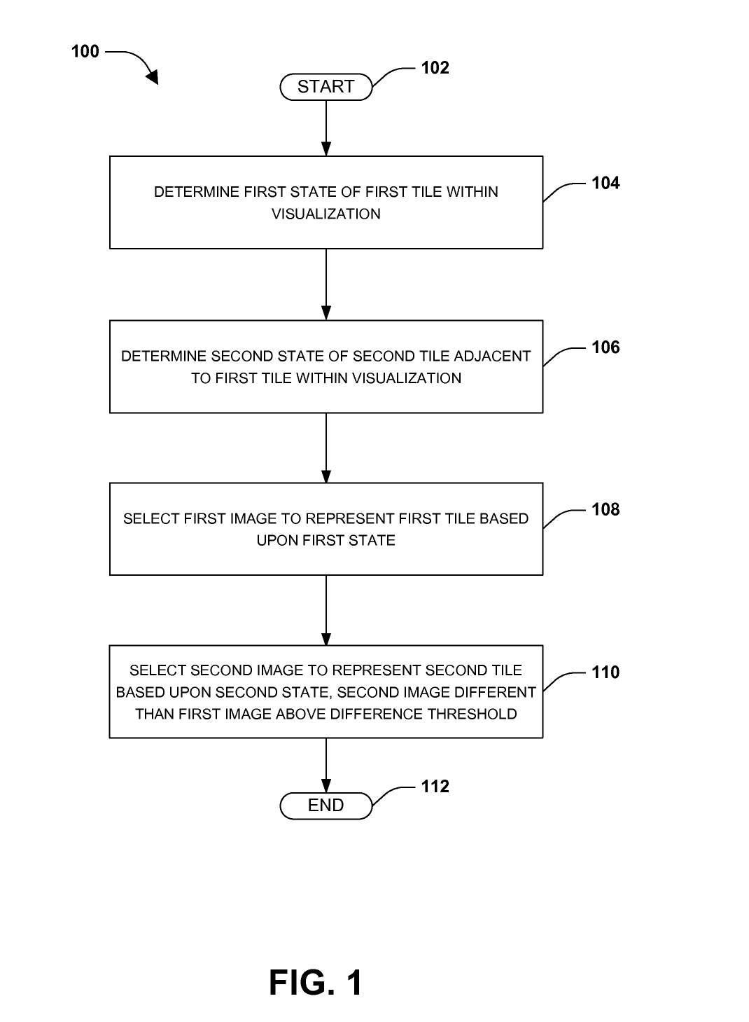

One embodiment of selecting images to represent tiles within a visualization is illustrated by an exemplary method 100 in FIG. 1. At 102, the method starts. In one example, a visualization may correspond to a visual interface comprising one or more tiles configured to convey information according to a tile format (e.g., a desktop visualization may comprise a set of tiles representing available applications for execution). A state of a tile may be determined based upon a variety of information, such as a device form factor (e.g., a device resolution, a device size, a device orientation), a current time, a current location, a user preference, a time at which the tile was last displayed, etc. Accordingly, images may be selected for tiles within the visualization based upon states of such tiles, which may result in a visually diverse visualization of state aware tiles.

At 104, a first state of a first tile within a visualization may be determined. For example, a first state of an email application tile within a desktop visualization may be determined (e.g., the first state may specify that the email application tile represents an application, that the application is an email application, that the device resolution/screen size is 500×500 pixels, that a user prefers large icons, etc.). At 106, a second state of a second tile adjacent to the first tile within the visualization may be determined. For example, a second state of an office application tile adjacent to the email application tile within the desktop visualization may be determined (e.g., the second state may specify that the office application tile represents an application, that the application is an office productivity suite, that the device resolution/screen size is 500×500 pixels, that the user prefers large icons, etc.).

It may be advantageous to select visually diverse images for the adjacent first and second tiles based upon the first state and the second state. At 108, a first image may be selected to represent the first tile based upon the first state. For example, an email icon image that is 50×50 pixels may be selected based upon the first state. At 110, a second image may be selected to represent the second tile based upon the second state. The second image may be selected, such that the second image and the first image may be visually different above a difference threshold (e.g., the difference threshold may specify that at least 20% of the pixels between the first and second image are different; identifiers, such as file names, for the first and second image are different; file sizes for the first and second image are different; etc.). For example, a pencil icon image that is 50×50 pixels may be selected based upon the second state and/or because the pencil icon image may differ from the email icon image above a difference threshold (e.g., the pencil icon image may have a different file name than the email icon image). In this way, images may be selected for respective tiles within the visualization so that the visualization comprises a set of visually diverse tiles (e.g., adjacent tiles may comprise visually different images (e.g., so that a user does not mistake one application/tile for the other)). At 112, the method ends.

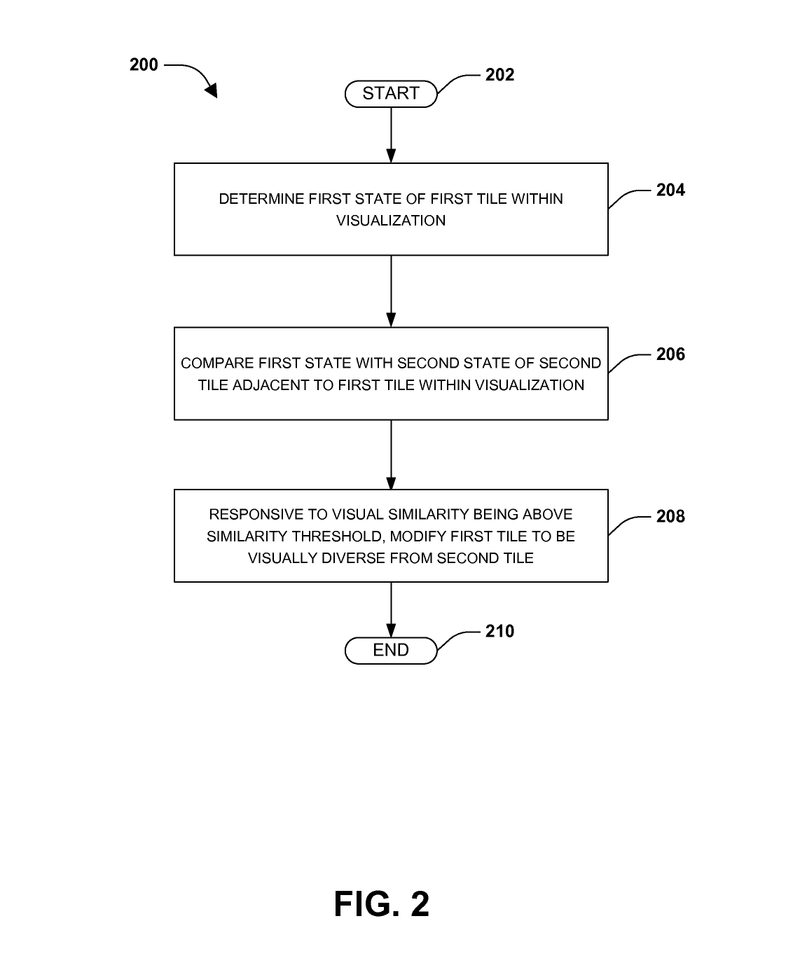

One embodiment of creating a visually diverse visualization is illustrated by an exemplary method 200 in FIG. 2. At 102, the method starts. In one example, a visualization may correspond to a visual interface comprising one or more tiles configured to convey information according to a tile format (e.g., a map application visualization may comprise a set of tiles representing locations and/or directions). A tile may correspond to an information tile, an application tile, a video tile, an image tile, and/or a variety of other tile types. A state of the tile may be determined based upon a variety of information, such as an image currently representing the tile (e.g., a background image), a device form factor (e.g., a device resolution, a device size, a device orientation), a current time, a current location, a user preference, a time at which the tile was last displayed, etc. Accordingly, one or more tiles within the visualization may be modified to create a visually diverse visualization (e.g., adjacent tiles represented by similar images may be modified to be visually diverse). It may be appreciated that the visualization may correspond to a variety of application user interfaces (e.g., a map application, an operating system, a search result interface, etc.) and/or device form factors (e.g., a mobile device, a tablet device, a desktop device, a smart phone device, etc.).

At 204, a first state of a first tile within a visualization may be determined. For example, a first state of a City (A) map tile within a map application visualization may be determined (e.g., the first state may specify that the City (A) map tile represents a location of City (A), that the location is represented by a first building icon image, that the first building icon image is 50×50 pixels, that the current time is 3:00 pm on Mar. 3, 2012, etc.). A second state of a City (B) map tile adjacent to the City (A) map tile within the map application visualization may be determined (e.g., the second state may specify that the City (B) map tile represents a location of City (B), that the location is represented by a second building icon image, that the second building icon image is 50×50 pixels, that the current time is 3:00 pm on Mar. 3, 2012, etc.). At 206, the first state and the second state may be compared to determine visual similarity. For example, a comparison of source files for the first building icon image and the second building icon image may indicate that the first building icon image and the second building icon image correspond to the same source file (e.g., a visually similarity of 100% may be determined based upon the first and second building icon images corresponding to the same source file, which may exceed a similarity threshold of 30% similarity).

It may be advantageous to modify the first tile and/or the second tile to create a visually diverse layout of such tiles within the mapping application visualization. At 208, responsive to the visual similarity being above a similarity threshold, the first tile may be modified to be visually diverse from the second tile below the similarity threshold. In one example, the first building icon image may be changed to a skyline icon image that is visually dissimilar from the second building icon image below the similarity threshold. In another example, a location of the first tile may be modified within the visualization (e.g., so that the first tile is not adjacent to the second tile and/or other tiles that may be visually similar to the first tile). In another example, the second tile may be modified as well as the first tile, such that the first tile and the second tile are visually diverse below the similarity threshold (e.g., the first building icon image and the second building icon image may be modified and/or replaced). In this way, one or more tiles within the visualization may be evaluated and/or modified to create a visually diverse visualization. At 210, the method ends.

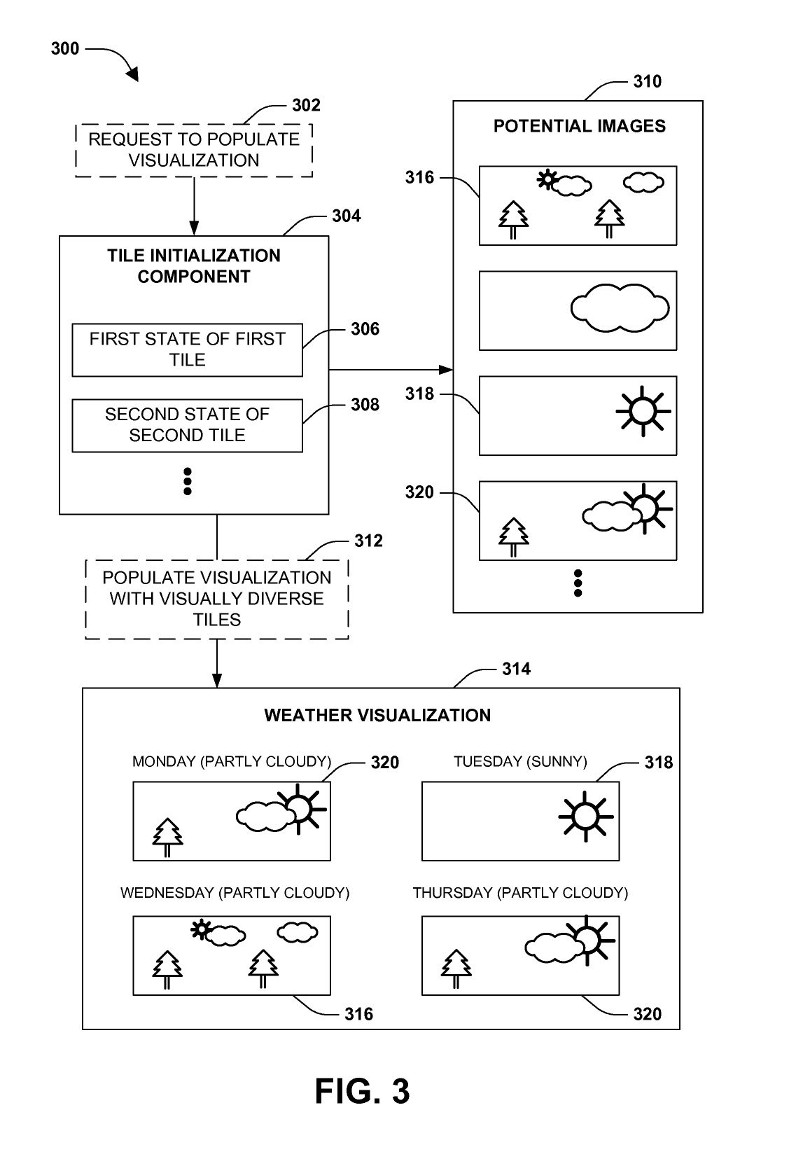

FIG. 3 illustrates an example of a system 300 configured for selecting images to represent tiles within a visualization. The system 300 may comprise a tile initialization component 304. The tile initialization component 304 may be configured to select images for tiles within the visualization so that the visualization comprises a diverse set of tiles (e.g., where adjacent tiles comprise visually diverse images). In one example, the tile initialization component 304 may receive a request 302 to populate a weather visualization 314 with one or more weather tiles (e.g., a Monday weather tile, a Tuesday weather tile, a Wednesday weather tile, a Thursday weather tile, etc.).

The tile initialization component 304 may be configured to determine a first state 306 of a first tile within the weather visualization 314 (e.g., the first state 306 of the Monday weather tile) and a second state 308 of a second tile adjacent to the first tile within the weather visualization 314 (e.g., the second state 308 of the Wednesday weather tile vertically adjacent to the Monday weather tile). For example, the first state 306 may specify that the Monday weather tile represents a weather condition of partly cloudy for Monday and/or that a current location of a device hosting the weather visualization 314 is a wooded area. The second state 308 may specify that the Wednesday weather tile represents a weather condition of partly cloudy for Wednesday and/or that the current location of the device hosting the weather visualization 314 is the wooded area.

The tile initialization component 304 may be configured to select a first image for the first tile based upon the first state 306. For example, a first partly cloudy image 320 within a set of potential images 310 may be selected because the Monday weather tile represents a partly cloudy day and/or because the current location of the device is the wooded area. The tile initialization component 304 may be configured to select a second image for the second tile, such that the second image is different than the first image above a difference threshold. For example, a second partly cloudy image 316 within the set of potential images 310 may be selected because the Wednesday weather tile represents a partly cloudy day, the current location of the device is the wooded area, and/or because the second partly cloudy image 316 differs from the first partly cloudy image 320 (e.g., assigned to the Monday weather tile and the Thursday weather tile that are adjacent to the Wednesday weather tile) above a difference threshold. For example, the first partly cloudy image 320 may visually differ from the second partly cloudy image 316 by greater than a 40% difference threshold. In this way, the tile visualization component 304 may populate 312 the weather visualization 314 with visually diverse tiles.

It may be appreciated that the tile initialization component 304 may be configured to evaluate other adjacent tiles when selecting the first image and/or the second image (e.g., the Monday weather tile may be compared with the Tuesday weather tile, the Wednesday weather tile may be compared with the Thursday weather tile, etc.). It may be appreciated that the tile initialization component 304 may be configured to evaluate and/or assign images to other tiles within the weather visualization 314 (e.g., the Tuesday weather tile may be assigned a sunny image 318, the Thursday weather tile may be assigned the partly cloudy image 320, and/or other weather tiles not illustrated may be assigned images). In another example, a different partly cloudy image may be chosen for Thursday so that Monday and Thursday are visually diverse given that they are diagonally adjacent. Any such arrangements and image selections are contemplated and not limited to the examples provided.

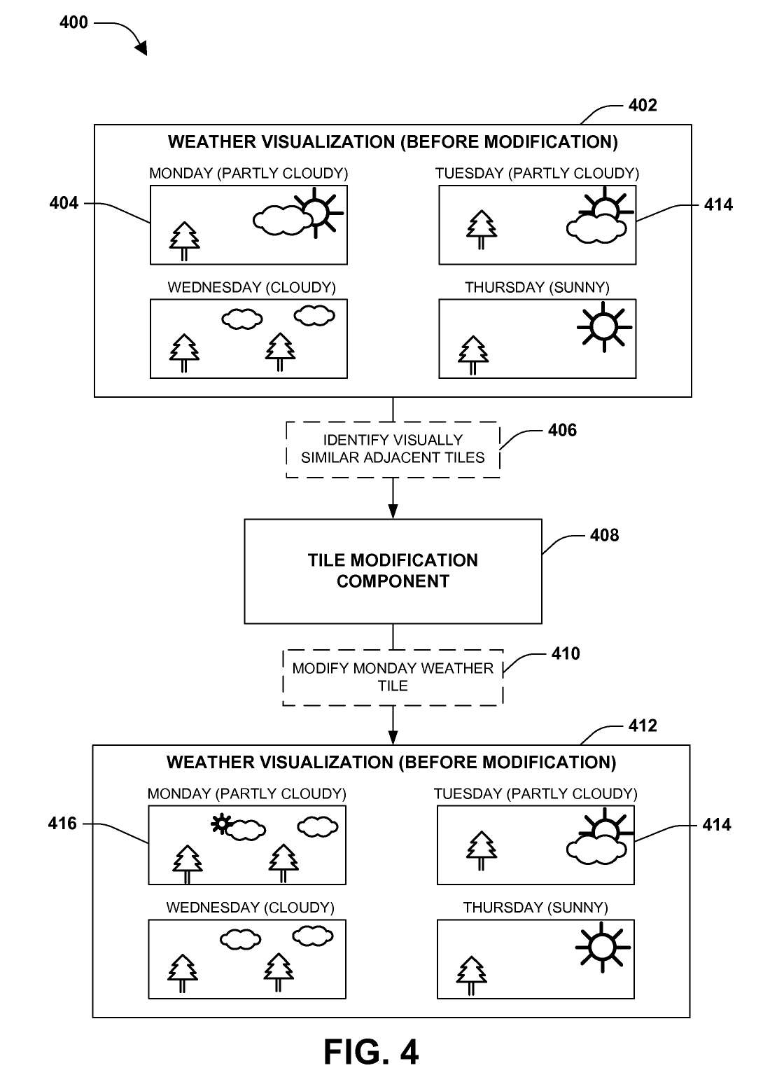

FIG. 4 illustrates an example of a system 400 configured for creating a visually diverse visualization. The system 400 may comprise a tile modification component 408. The tile modification component 408 may be configured to modify one or more tiles within a visualization to create the visually diverse visualization. In one example, the tile modification component 408 may be configured to identify 406 and/or modify 410 visually similar adjacent weather tiles within a weather visualization (e.g., weather visualization 402 before modification). For example, the tile modification component 408 may determine a third state of a third tile (e.g., a Monday weather tile) within the weather visualization 402 and a fourth state of a fourth tile adjacent to the third tile within the weather visualization 402 (e.g., a Tuesday weather tile horizontally adjacent to the Monday weather tile). The third state may specify that the Monday weather tile comprises a third partly cloudy background image 404 used represent a partly cloudy weather condition for Monday. The fourth state may specify that the Tuesday weather tile comprises a fourth partly cloudy background image 414 used to represent a partly cloudy weather condition for Tuesday.

The tile modification component 408 may be configured to compare the third state with the fourth state to determine visual similarity between the third tile and the fourth tile within the weather visualization 402. For example, the tile modification component 408 may compare the third partly cloudy background image 404 with the fourth partly cloudy background image 414 to determine whether such images are visually similar above a similarity threshold (e.g., the third partly cloudy background image 404 and the fourth partly cloudy background image 414 may be 80% similar because the tree and the cloud may be slightly different positions within such images). Responsive to the visual similarity being above the similarity threshold (e.g., 70% similarity threshold), the tile modification component 408 may be configured to modify the third tile to be visually diverse from the fourth tile below the similarity threshold. For example, the tile modification component 408 may modify 410 the Monday weather tile by replacing the third cloudy background image 404 with a new cloudy background image 416 that is visually diverse from the fourth cloudy background image 414, thus resulting in the weather visualization 412 after modification. In this way, the tile modification component 408 may modify one or more tiles to create a visually diverse weather visualization.

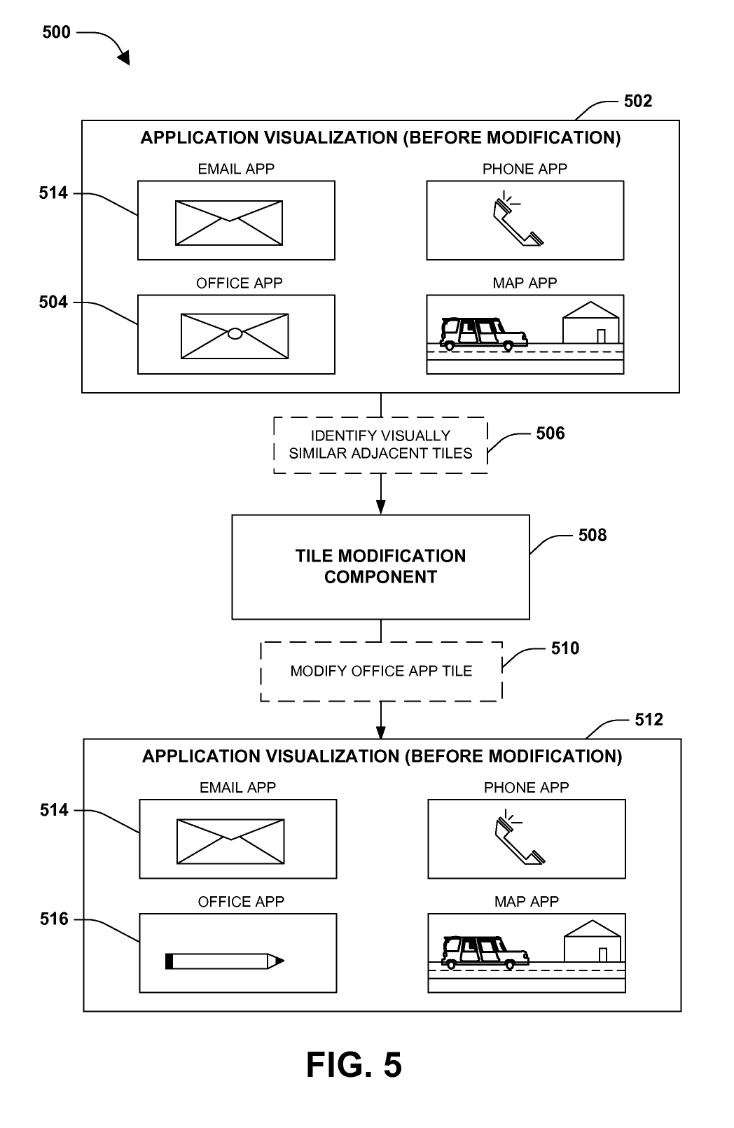

FIG. 5 illustrates an example of a system 500 configured for creating a visually diverse visualization. The system 500 may comprise a tile modification component 508. The tile modification component 508 may be configured to modify one or more tiles within a visualization to create the visually diverse visualization. In one example, the tile modification component 508 may be configured to identify 506 and/or modify 510 visually similar adjacent app tiles within an application visualization (e.g., application visualization 502 before modification). For example, the tile modification component 508 may determine a third state of a third tile (e.g., an office app tile) within the application visualization 502 and a fourth state of a fourth tile adjacent to the third tile within the application visualization 502 (e.g., an email app tile vertically adjacent to the office app tile). The third state may specify that the office app tile comprises a third envelop image 504 used to represent an office productivity suite. The fourth state may specify that the email app tile comprises a fourth envelope image 514 used to represent an email application.

The tile modification component 508 may be configured to compare the third state with the fourth state to determine visual similarity between the third tile and the fourth tile within the application visualization 502. For example, the tile modification component 508 may compare the third envelope image 504 with the fourth envelope image 514 to determine whether such images are visually similar above a similarity threshold (e.g., the third envelope image 504 and the fourth envelope image 514 may be 86% similar because both images comprise similar but not identical envelopes). Responsive to the visual similarity being above the similarity threshold (e.g., 70% similarity threshold), the tile modification component 508 may be configured to modify the third tile to be visually diverse from the fourth tile below the similarity threshold. For example, the tile modification component 508 may modify 510 the office app tile by replacing the third envelope image 504 with a new pencil image 516 that is visually diverse from the fourth envelope image 514, thus resulting in the application visualization 512 after modification. In this way, the tile modification component 508 may modify one or more tiles to create a visually diverse application visualization.

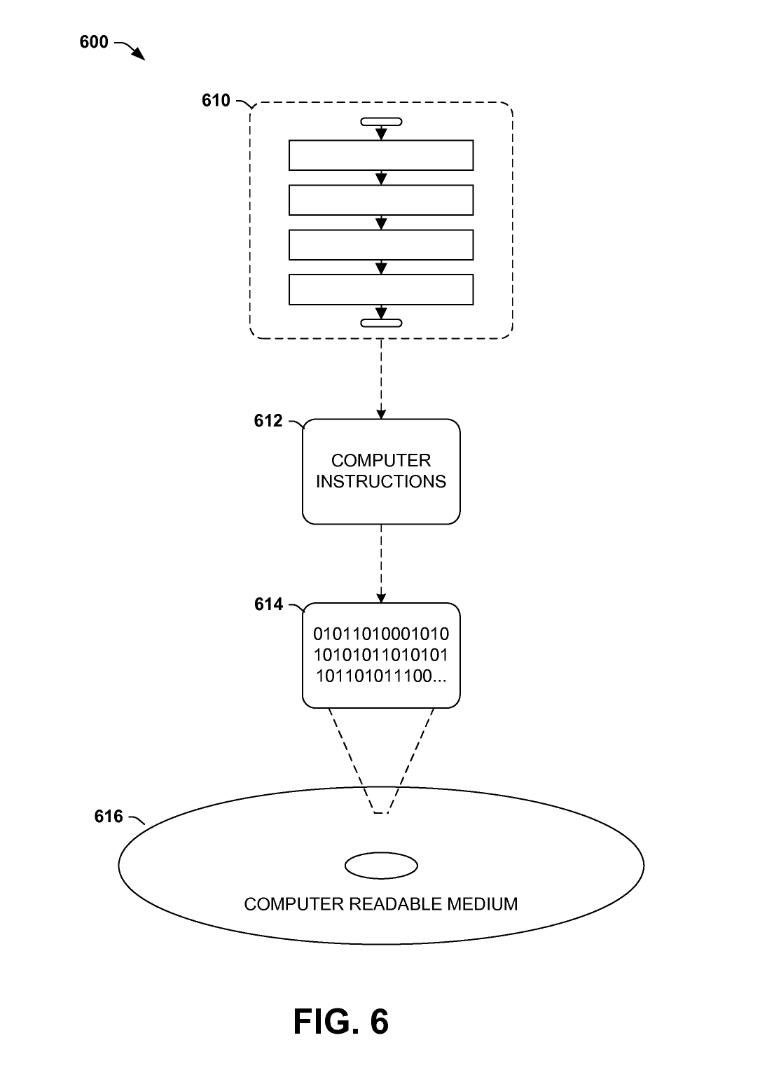

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 616 (e.g., a CD-R, DVD-R, or a platter of a hard disk drive), on which is encoded computer-readable data 614. This computer-readable data 614 in turn comprises a set of computer instructions 612 configured to operate according to one or more of the principles set forth herein. In one such embodiment 600, the processor-executable computer instructions 612 may be configured to perform a method 610, such as at least some of the exemplary method 100 of FIG. 1 and/or at least some of exemplary method 200 of FIG. 2, for example. In another such embodiment, the processor-executable instructions 612 may be configured to implement a system, such as at least some of the exemplary system 300 of FIG. 3, at least some of exemplary system 400 of FIG. 4, and/or at least some of exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

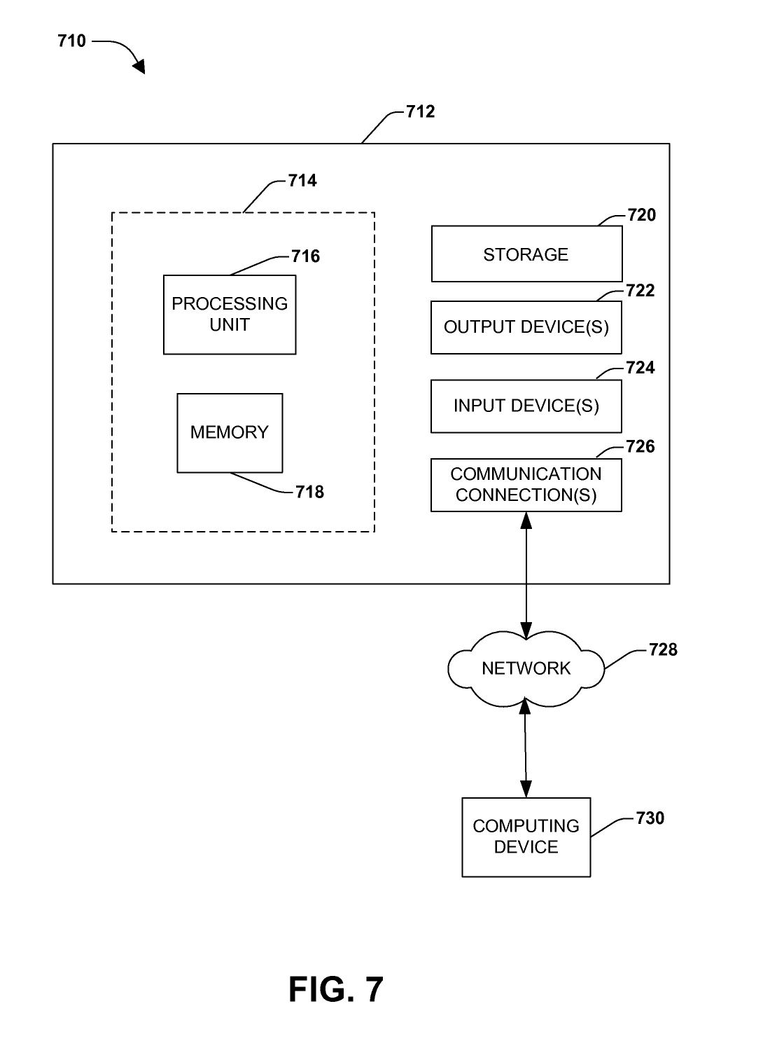

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for creating a visually diverse visualization, comprising:
determining a first state of a first tile within a visualization;
comparing the first state with a second state of a second tile adjacent to the first tile within the visualization to determine visual similarity; and
responsive to the visual similarity being above a similarity threshold, modifying the first tile to be visually diverse from the second tile below the similarity threshold.

2. The method of claim 1, the determining a first state comprising:
evaluating a device form factor of a device hosting the visualization, the device form factor corresponding to at least one of a device resolution, a device size, and a device orientation.

3. The method of claim 1, the determining a first state comprising:
evaluating at least one of a time, a location of a device hosting the visualization, and a user preference.

4. The method of claim 1, the determining a first state comprising:
evaluating a time at which the first tile was last displayed within the visualization.

5. The method of claim 1, the modifying the first tile comprising:
modifying a first image representing the first tile that is visually diverse from a second image representing the second tile below the similarity threshold.

6. The method of claim 1, the modifying the first tile comprising:
modifying a location of the first tile within the visualization.

7. The method of claim 1, the first tile within the visualization comprising at least one of an information tile, an application tile, a video tile, and an image tile.

8. The method of claim 1, the comparing the first state with a second state comprising:
determining that a first image representing the first tile is similar to a second image representing the second tile above the similarity threshold.

9. The method of claim 1, comprising:
responsive to the visual similarity being above a similarity threshold, modifying the second tile as well as the first tile such that the first tile and the second tile are visually diverse below the similarity threshold.

10. A computer-readable medium comprising processor-executable instructions that when executed perform a method for selecting images to represent tiles within a visualization, comprising:
determining a first state of a first tile within a visualization;
determining a second state of a second tile adjacent to the first tile within the visualization;
selecting a first image to represent the first tile based upon the first state; and
selecting a second image to represent the second tile based upon the second state, the second image different than the first image above a difference threshold.

11. The method of claim 10, the selecting the second image comprising:
comparing the first state with the second state to determine visual similarity of one or more potential images for representing the first tile and the second tile.

12. The method of claim 10, the selecting the second image comprising:
refraining from representing the second tile with a third image based upon a visual similarity between the first image and the third image being above a similarity threshold.

13. The method of claim 10, the determining a first state comprising:
evaluating a device form factor of a device hosting the visualization, the device form factor corresponding to at least one of a device resolution, a device size, and a device orientation.

14. The method of claim 10, the determining a first state comprising:
evaluating at least one of a time, a location of a device hosting the visualization, and a user preference.

15. The method of claim 10, the determining a first state comprising:
evaluating a time at which the first tile was last displayed within the visualization.

16. A system for selecting images to represent tiles within a visualization, comprising:
a tile initialization component configured to:
determine a first state of a first tile within a visualization;
determine a second state of a second file adjacent to the first tile within the visualization;
select a first image to represent the first tile based upon the first state; and
select a second image to represent the second tile based upon the second state, the second image different than the first image above a difference threshold.

17. The system of claim 16, comprising:
a tile modification component configured to:
determine a third state of a third tile within a visualization;
compare the third state with a fourth state of a fourth tile adjacent to the third tile within the visualization to determine visual similarity; and
responsive to the visual similarity being above a similarity threshold, modify the third tile to be visually diverse from the fourth tile below the similarity threshold.

18. The system of claim 16, the tile initialization component configured to:
evaluate at least one of a device form factor of a device hosting the visualization, a time, a location of the device, a user preference, and a time at which the first tile was last displayed within the visualization to determine at least one of the first state and the second state.

19. The system of claim 17, the tile modification component configured to:
modify a third image representing the third tile that is visually diverse from a fourth image representing the fourth tile below the similarity threshold.

20. The system of claim 16, at least one of the first tile and the second tile within the visualization comprising at least one of an information tile, an application tile, a video tile, and an image tile.
